(19) United States
(12) Patent Application Publication
(10) Pub. No.: US 2003/0092314 A1
(43) Pub. Date: May 15, 2003

(54) Network interface panel

(76) Inventors: William B. Whiteside, Ball Ground, GA (US); Richard D. Hennum, Buford, GA (US); Nicholas Lam, Duluth, GA (US)

Correspondence Address: ALCOA INC, ALCOA TECHNICAL CENTER, 100 TECHNICAL DRIVE, ALCOA CENTER, PA, 15069-0001, US

(21) Appl. No.: 10/285,971

(22) Filed: Oct. 31, 2002

Related U.S. Application Data
(60) Provisional application No. 60/337,309, filed on Nov. 5, 2001.

(51) Int. Cl. H01R 13/60

(52) U.S. Cl. 439/540.1

(57) ABSTRACT

An interface panel comprises an enclosure defining an interior space, a first bracket positioned within the interior space and having a first section for engaging portions of a first pair of clips of a mounting bracket, a second bracket positioned within the interior space and having a first section for engaging portions of a second pair of clips of a mounting bracket, a first release member for disengaging the first pair of clips from the first bracket, and a second release member for disengaging the second pair of clips from the second bracket. Each of the release members can be positioned adjacent to one of the brackets and mounted to be movable with respect to the adjacent bracket. The release members include clip separating means for separating a pair of clips of the mounting bracket.

### CROSS-REFERENCE TO RELATED APPLICATION

This application claims the benefit of U.S. Provisional Patent Application Serial No. 60/337,309, filed Nov. 5, 2001.

### FIELD OF THE INVENTION

This invention relates generally to the field of communications interface panels, and in particular, to panels that are compatible with industry standard mounting brackets.

### BACKGROUND OF THE INVENTION

Modular electrical connector products for the telecommunications industry, particularly plugs and jacks, have achieved wide acceptance. Modular jacks may be mounted in various panel configurations, such that the ends of the modular jacks are in alignment with apertures in the panel, and generally flush with the front face of the panel. Conventional electronic modules for high-speed telecommunication and networking applications are typically housed in a cabinet that is specifically designed to house such electronic modules. Typically, a vertically oriented rack is positioned within the cabinet, and electronic modules are fastened to the rack. The electronic modules can be stacked one on top of the other in a vertically stacked configuration.

Telecommunication signals must be routed to and from the plurality of electronic modules within the cabinet. This is typically accomplished by providing a communications panel mounted to the rack within the cabinet. Communications interface panels are typically mounted adjacent to the backside of the cabinet to allow a technician to access the panel.

There are several disadvantages with these conventional communications panels. First, the size of conventional communications panels is large due to the large number of connectors that are required to provide telecommunications signals to the plurality of electronic modules within the cabinet. These cabinets typically have strict dimensional requirements, and the large size of conventional communications panels greatly reduces the amount of space in the cabinet that could otherwise be used for other various electronic functions. Moreover, routing numerous individual cables into the cabinet also requires a large amount of physical space, and may block the required airflow through the cabinet, which may result in the overheating of the various electronic modules within the cabinet.

Relevant in the context of the present invention is what is known as a type 89D or a type 89B mounting bracket, which is a telephone industry standard. An “89 type” bracket is designed to receive what is known in the telephone industry as a “66 type” insulation displacement cross-connect field block. The “66 type” blocks normally support multiple rows connectors, each row having a pair of two-connector sets, with the two connectors of each set being electrically connected whereby a convenient electrical connection may be made between two wires. The “66 type” blocks have a generally flat rear surface which contacts rectangular spacer posts which are part of the “89 type” bracket, such that a wire guideway is defined between the rear surface of the “66 type” block and the rear of the “89 type” bracket itself. The “89 type” bracket includes retaining clips designed to secure the “66 type” connection block by a mounting flange.

There is a need for an enclosure that can be mounted to a standard mounting bracket, yet can accommodate a large number of connection devices.

### SUMMARY OF THE INVENTION

An interface panel comprises an enclosure defining an interior space, a first bracket positioned within the interior space and having a first section for engaging portions of a first pair of clips of a mounting bracket, a second bracket positioned within the interior space and having a first section for engaging portions of a second pair of clips of a mounting bracket, a first release member for disengaging the first pair of clips from the first bracket, and a second release member for disengaging the second pair of clips from the second bracket.

Each of the release members can be positioned adjacent to one of the brackets and mounted to be movable with respect to the adjacent bracket. The release members include clip-separating means for separating a pair of clips of the mounting bracket. Each of the clip-separating means can include two bent ends spaced to engage camming surfaces of the clips of the mounting bracket.

The brackets and release members can be positioned adjacent to interior surfaces of the ends of the enclosure.

Each of the release members can include a tab that extends through an opening in the enclosure.

The first section of each of the brackets can further comprise first and second bent portions for providing a biasing force for pushing the enclosure away from the mounting bracket.

The first section of each of the brackets can also comprise first and second tabs for preventing lateral movement of the enclosure with respect to the mounting bracket.

The panel can further include means for supporting connectors within the enclosure, wherein the means for supporting connectors within the enclosure can comprise a printed circuit board, or wherein pairs of the connectors can be fastened to the enclosure by a single fastener.

### BRIEF DESCRIPTION OF THE DRAWINGS

FIG. 1 is an isometric view of a panel constructed in accordance with the invention.

FIG. 2 is an isometric view of another panel constructed in accordance with the invention in combination with a standard mounting bracket.

FIG. 3 is an isometric view of a mounting bracket and a release member used in the enclosures of FIGS. 1 and 2.

FIG. 4 is an isometric view of another panel constructed in accordance with the invention, in combination with a standard mounting bracket.

FIG. 5 is an isometric view of a connector module for use in the panel of FIG. 4.

### DETAILED DESCRIPTION OF THE PREFERRED EMBODIMENT

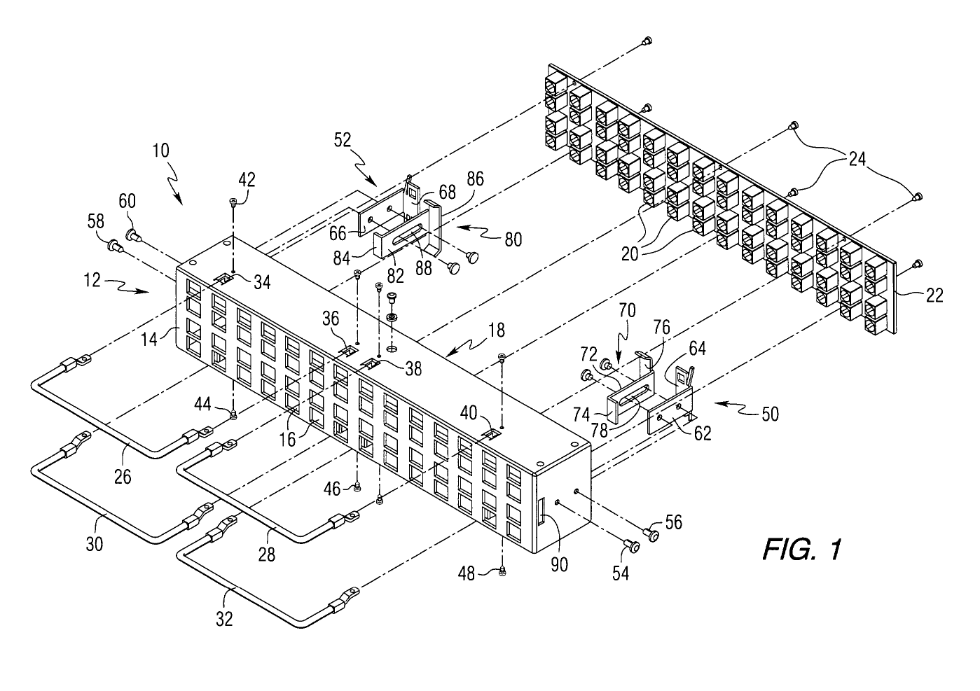

The invention is described in several embodiments in the drawings in which identical item numbers are used to identify identical components. Referring to the drawings, FIG. 1 is an isometric view of a panel 10 constructed in accordance with the invention. The panel includes an enclosure 12 having a front 14 that defines a plurality of openings 16 for receiving communications jacks, and a generally rectangular interior 18 for receiving communication components. In this embodiment, the communications jacks 20 are mounted on a printed circuit board 22 that can be attached to the interior of the enclosure by fasteners 24. Handles 26, 28, 30 and 32 have offset ends that can enter apertures in the sides of the enclosure, as illustrated by apertures 34, 36, 38 and 40. Fasteners, for example screws 42, 44, 46 and 48, are used to secure the handles to the enclosure. Brackets 50 and 52 are positioned adjacent to interior surfaces of opposite ends of the enclosure and held in place by fasteners 54, 56, 58 and 60. Bracket 50 includes a first section 62 having openings for receiving fasteners 54 and 56, and a second section 64 extending substantially perpendicularly from one end of the first section. Bracket 52 includes a first section 66 having openings for receiving fasteners 58 and 60, and a second section 68 extending substantially perpendicularly from one end of the first section. The second sections of brackets 50 and 52 provide a means for connecting the enclosure to a mounting bracket as will be described in more detail below.

A first release member 70 is mounted adjacent to bracket 50 and includes a first section 72, a tab 74 extending substantially perpendicularly from a first end of the first section, and a second section 76 extending substantially perpendicularly from a second end of the first section. Fasteners 54 and 56 pass through an elongated opening 78 in bracket 70, and permit release member 70 to move linearly in a direction toward or away from the rear of the enclosure. A second release member 80 is mounted adjacent to bracket 52 and includes a first section 82, a tab 84 extending substantially perpendicularly from a first end of the first section, and a second section 86 extending substantially perpendicularly from a second end of the first section. Fasteners 58 and 60 pass through an elongated opening 88 in bracket 80, and permit release member 80 to move linearly in a direction toward or away from the rear of the enclosure. Tabs 74 and 84 extend through the sides of the enclosure so that the release members 70 and 80 can be manually moved to assist in disengaging the enclosure from a mounting bracket as described in detail below. For example, tab 74 extends through opening 90 in the enclosure.

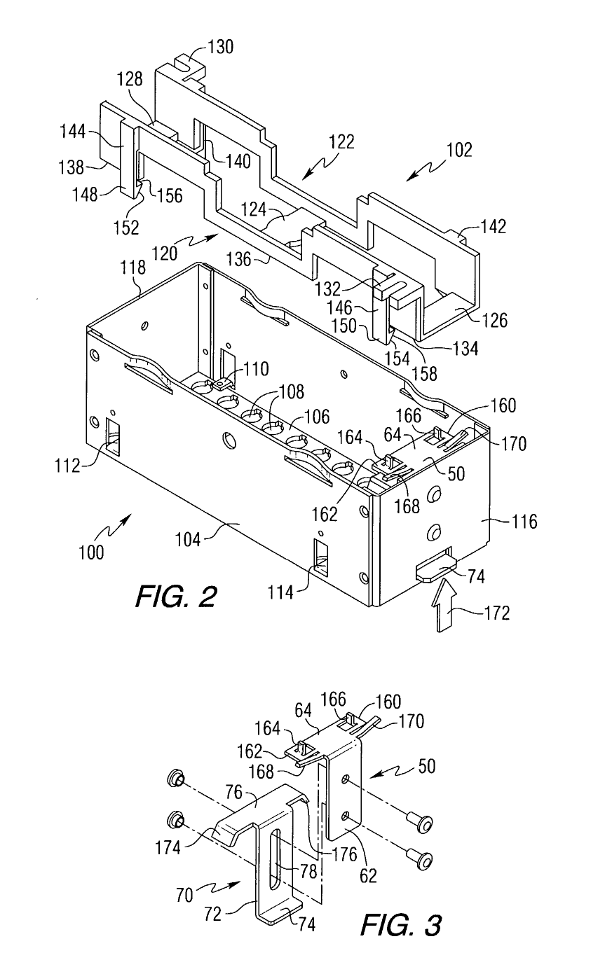

FIG. 2 is an isometric view of another panel 100 constructed in accordance with another embodiment of the invention, in combination with a standard mounting bracket 102. Panel 100 includes a generally rectangular enclosure 104 having a front 106 that defines a plurality of openings 108 for receiving communication devices. Tabs 110, 112, 114 are provided to attach a printed circuit board that contains the communication devices. Bracket 52 and release member 80 are shown to be mounted adjacent to an interior surface of one side 116 of the enclosure 104. It should be understood that a second bracket and a second release member, not shown, will be mounted adjacent to an interior surface of another side 118 of the enclosure 104.

Mounting bracket 102 can comprise an industry standard “89 type” bracket. The bracket 102 typically comprises a single integral plastic piece, formed by injection molding, and includes a first side 120 and a second side 122 which are mirror images of each other, and are interconnected by a system of structural cross members 124, 126 and 128. The bracket 102 includes a pair of mounting members 130 and 132 by which the bracket 102 is typically secured to a flat panel, such as a wood panel, in turn secured to a wall within an equipment closet.

Each of the mounting bracket sides includes a set of surfaces, for example 134, 136 and 138, designed to contact the underside of a “66 type” block. Four resilient retaining clips 140, 142, 144 and 146 extend upwardly from the base of the bracket 102. To provide snap-on capability, each of the retaining clips has a head, for example 148, 150, including an inclined camming surface 152, 154 which serves to deflect the entire head 148, 150 when a “66 type” block is being installed, and an underside engaging surface, for example 156, 158, intended to engage the mounting flange of a “66 type” block.

In the panels of this invention, the engaging surfaces 156, 158 of the mounting bracket clips engage the edges 160 and 162 of section 64 of bracket 50. Tabs 164 and 166 on section 64 engage the interior of the sides of the mounting bracket to prevent lateral movement of the enclosure with respect to the mounting bracket. Tabs 168 and 170 are bent outward to provide a force against the cross member 126 of the mounting bracket and thereby further secure the engaging surfaces of the resilient clips to the edges of section 64 of bracket 50. While not shown in this view, it should be apparent that clips 140 and 144 of the mounting bracket will engage a section of another bracket (similar to bracket 52 of FIG. 1) mounted adjacent to the interior surface of end 118 of the enclosure.

To release the enclosure from the mounting bracket, tab 74 can be moved in the direction indicated by arrow 172 to spread the mounting bracket resilient clips and thereby disengage the resilient clips from the edges of section 64 of bracket 50. This can be more clearly seen by referring to FIG. 3.

FIG. 3 is an isometric view of a bracket 50 and a release member 70 used in the enclosures of FIGS. 1 and 2. In FIG. 3, section 76 of release member 70 is seen to have bent ends 174, 176 which are positioned to engage the camming surfaces of the clips in mounting bracket 102. As release member 70 is moved toward mounting bracket 102, the bent ends 174, 176 force the resilient clips outward and thereby disengage the resilient clips from the edges 160, 162 of section 64 of bracket 50.

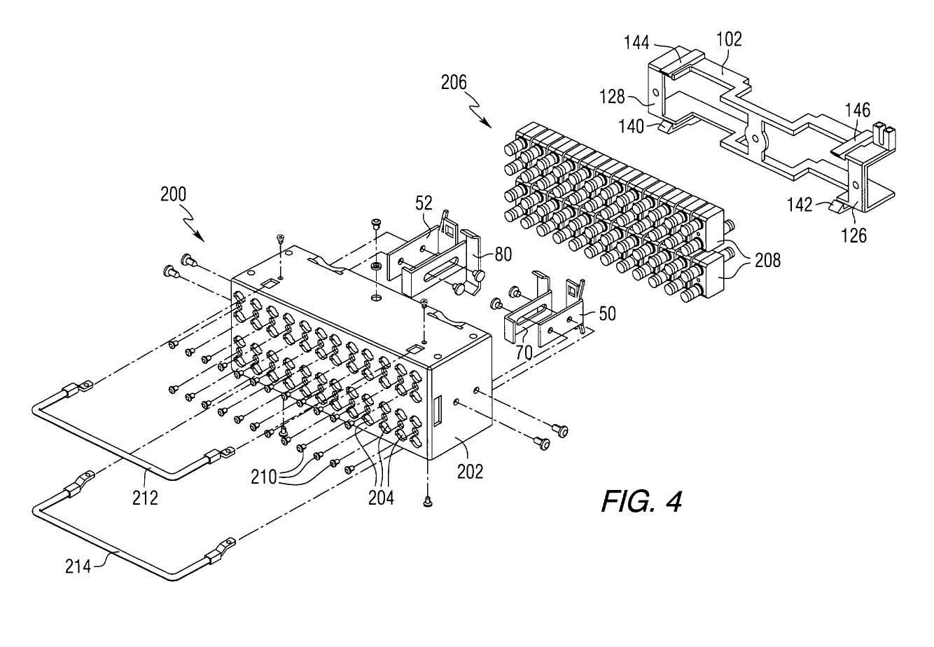

FIG. 4 is an isometric view of another panel 200 constructed in accordance with the invention, in combination with a standard mounting bracket 102. Panel 200 includes an enclosure 202 having a side that defines a plurality of openings 204 for receiving a plurality of connectors 206. The connectors are in the form of modules 208. Each of the modules can be connected to the side of the enclosure using a single fastener, such as screws 210. Handles 212 and 214 are provided for attachment to the enclosure in a manner similar to that described for the handles of FIG. 1.

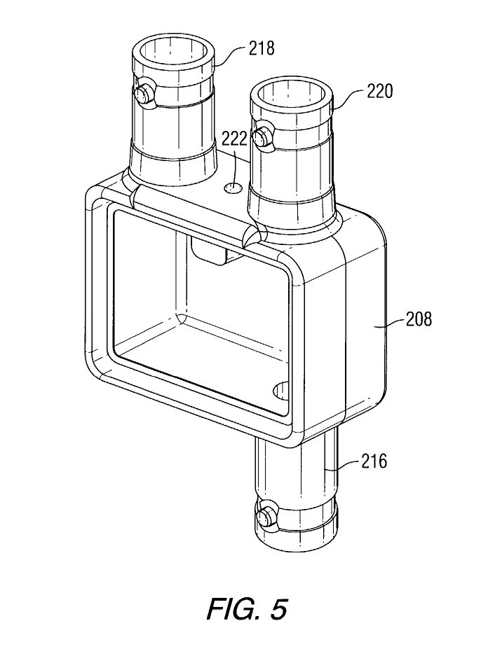

FIG. 5 is an isometric view of a connector module 208 that can be used in the panel of FIG. 4. The connector module 208 includes an input port 216 and two output ports 218, 220. An opening 222 is provided to receive a fastener, such as a screw, to secure the connector module to the enclosure of the panel.

In each of the disclosed embodiments, brackets at each end of the enclosure snap into the retaining clips of the 89B/D bracket. When the panel is positioned and pressed against the 89B/D bracket, edges of the brackets snap into place under the 89B/D bracket's clips to secure the unit in place. Since the width of the panel exceeds that of the 89B/D bracket, release of the unit from the bracket with other units adjacent (above and/or below) would be difficult by reaching in with one's hand. Therefore, the panels of this invention include release members. In the disclosed embodiment, a tool-less slide release has been included. Tabs on the release members located at the ends of the unit, can be depressed to slide the release brackets toward the rear of the enclosure. This expands the retaining clips of the 89B/D bracket to release their hold on the panel.

Two approaches to mounting the components with the enclosure have been presented. The printed circuit board approach of FIG. 1 utilizes connectors that are supported by the printed circuit board. By combining all circuits onto a single board, a cost advantage can be achieved over the use of multiple boards. With the modular design of FIG. 4, the modules can be fixed to the panel with a single screw.

The panels of this invention can be vertically mounted for customer handoff of DS1 circuits and associated bridged monitor points via RJ48 jacks. The panels can be conveniently mounted indoors using one or two vertically aligned, industry standard 89B or 89D brackets speeding installation and lowering costs. The panels can provide the basic communications circuit hand-off function plus a circuit monitor access function for each circuit in a slim, space-saving design.

The panels can be used for customer hand-off of DS3 circuits and associated bridged transmit and receive path monitoring points via female BNC jacks.

The panels can also be used to provide the basic hand-off function plus a circuit monitor access function for each circuit direction. Network connections can be made via female 75-ohm BNC jacks at the rear of the unit. Customer and circuit path monitor connections can be positioned on the front.

The panels of this invention can be vertically mounted in communications closets or customer sites to support horizontally oriented rack of wall mounted panels. The panels provide the ability to mount interface connectors in a restricted space and can be mounted side-by-side or above and below each other. The panels provide the stability and rigidity needed for cable management.

The compact design of panels constructed in accordance with this invention eliminate the need for a wall mounted chassis and the associated repetitive packaging of individual plug-in modules. These panels also save space in overburdened telecommunications closets.

This invention provides panels for mounting DS1, DS3 or other low signal level circuit connectors using a standard type 89B or 89D wall mounting bracket. The enclosure can be long enough to span multiple mounting brackets.

While specific embodiments of the invention have been illustrated and described herein, it should be understood that numerous modifications and changes will occur to those skilled in the art. For example, while the illustrated embodiments of the enclosures have a plurality of identical apertures, it will be appreciated that various different size apertures may be provided, to support any desired forms of connectors. It is intended that all such modifications and changes fall within the scope of the invention as defined by the claims.

What is claimed is:

1. An interface panel comprising:
an enclosure defining an interior space;
a first bracket positioned within the interior space and having a first section for engaging portions of a first pair of clips of a mounting bracket;
a second bracket positioned within the interior space and having a first section for engaging portions of a second pair of clips of a mounting bracket;
means for disengaging the first pair of clips from the first bracket; and
means for disengaging the second pair of clips from the second bracket.

2. A panel according to claim 1, wherein the means for disengaging the first pair of clips from the first bracket comprises a first release member positioned adjacent to the first bracket and being movable with respect to the first bracket, the first release member including clip separating means for separating the first pair of clips of the mounting bracket; and wherein the means for disengaging the second pair of clips from the second bracket comprises a second release member positioned adjacent to the second bracket and being movable with respect to the second bracket, the second release member including clip separating means for separating the second pair of clips of the mounting bracket.

3. A panel according to claim 2, wherein the first release member clip separating means comprises a first section having two bent ends spaced to engage camming surfaces of the first pair of clips of the mounting bracket; and wherein the second release member clip separating means comprises a first section having two bent ends spaced to engage camming surfaces of the second pair of clips of the mounting bracket.

4. A panel according to claim 2, wherein the first bracket and the first release member are positioned adjacent to each other and adjacent to an interior surface of a first end of the enclosure; and wherein the second bracket and the second release member are positioned adjacent to each other and adjacent to an interior surface of a second end of the enclosure.

5. A panel according to claim 2, wherein the first release member includes a tab that extends through a first opening in the enclosure; and wherein the second release member includes a tab that extends through a second opening in the enclosure.

6. A panel according to claim 1, wherein the first section of the first bracket further comprises first and second bent portions for providing a biasing force for pushing the enclosure away from the mounting bracket; and wherein the first section of the second bracket further comprises first and second bent portions for providing a biasing force for pushing the enclosure away from the mounting bracket.

7. A panel according to claim 1, wherein the first section of the first bracket further comprises first and second tabs for preventing lateral movement of the enclosure with respect to the mounting bracket; and wherein the first section of the second bracket further comprises first and second tabs for preventing lateral movement of the enclosure with respect to the mounting bracket.

8. A panel according to claim 1, further comprising means for supporting connectors within the enclosure.

9. A panel according to claim 8, wherein the means for supporting connectors within the enclosure comprises a printed circuit board.

10. A panel according to claim 8, wherein the pairs of the connectors are fastened to the enclosure by a single fastener.
